(19) United States
(12) Patent Application Publication
(10) Pub. No.: US 2016/0148317 A1
(43) Pub. Date: May 26, 2016

(54) MOBILE DEVICE FOR MANAGING HEALTHCARE TRANSACTION DATA, COMPUTER PROGRAM PRODUCT AND SYSTEM FOR THE SAME

(71) Applicant: HSAC, LLC., McLean, VA (US)

(72) Inventors: Aaron D. BENWAY, McLean, VA (US); Denise K. HALTER, Monrovia, MD (US)

(21) Appl. No.: 14/588,206

(22) Filed: Dec. 31, 2014

Related U.S. Application Data
(60) Provisional application No. 62/084,380, filed on Nov. 25, 2014.

(51) Int. Cl. G06Q 40/08

(52) U.S. Cl. CPC G06Q 40/08; G06Q 50/22

(57) ABSTRACT

A mobile device for managing healthcare transaction data is provided. The mobile device includes an I/O interface unit, an image capture unit, a network unit configured to communicate with a financial institution having financial data of the user and to transmit a claim request documentation for a qualifying expense to at least one of a health savings account custodian and a health insurance provider, and a computing unit coupled to the I/O interface unit. The computing unit is configured to receive a first healthcare transaction data from at least one of the image capture unit in the mobile device, a payment unit in the mobile device, and the input from the user, and a second healthcare transaction data from the financial institution. The computing unit is configured to determine whether the first healthcare transaction data and the second healthcare transaction data include a qualifying expense for reimbursement.

### FIELD OF THE INVENTION

The present disclosure relates generally to a mobile device, and more particularly to a mobile device for managing healthcare transaction data.

### BACKGROUND OF THE INVENTION

Mobile devices, such as smart phones and tablets, are becoming increasingly popular. These come in a variety of models with varying operating systems, mobile carriers, and hardware and software resources. As mobile devices become more popular, there is a growing demand for applications to use on them.

Mobile device includes various consumer components, such as: a digital camera; a media player; a GPS navigation; a touchscreen display panel; and an internet unit. Mobile device have become a modern-day necessity and can be used for a user's daily life activities. For instance, the user can use the mobile device to collect and manage data. The user can use an increasingly high resolution camera of the mobile device to keep receipts and other documents in an electronic format. Touchscreen or other input devices associated with the mobile device can be used for inputting any data directly by the user. Memory and computing units in the mobile device can save and manage the data, both onboard and remote (“cloud”) storage. Furthermore, an internet connectivility of the mobile device enables it to communicate with other websites, applications as well. In addition, today there are apps that allow one to control his or her home devices and processes, such as turning on and off lights; locking doors; and managing kitchen equipment.

In another area, the medical system and health insurance policies of today often require the user to manage healthcare transaction data over time. Furthermore, in a consumer-driven health environment where users are increasingly responsible for the initial, and larger deductible managing receipts and out of pocket expenses is quickly becoming an important financial saving and long-term wealth budding strategy. Thus, there is a need for a mobile device with application software running thereon for managing healthcare transaction data.

### SUMMARY OF THE INVENTION

In view of the aforementioned needs, the present disclosure provides a mobile device for managing healthcare transaction data for tax-advantaged accounts. The mobile device includes an I/O interface unit configured to receive an input from a user, an image capture unit configured to capture an image and coupled to the I/O interface unit, and a network unit coupled to the I/O interface unit and configured to communicate with one or a multiple of financial institutions having financial data of the user at which the user has an account. The mobile device also includes a unit to transmit documentation for a claim request for a qualifying expense to at least one of a health savings account custodian and a health insurance provider, and includes a computing unit coupled to the I/O interface unit.

The computing unit is configured to receive a first healthcare transaction data from at least one of the image capture unit in the mobile device, a payment unit in the mobile device, and the input from the user, and a second healthcare transaction data from the financial institution. The computing unit is configured to determine whether the first healthcare transaction data and the second healthcare transaction data include a qualifying expense for reimbursement.

The mobile device includes a memory unit coupled to the I/O interface unit and configured to store the first healthcare transaction data and the second healthcare transaction data. The mobile device also includes a display unit coupled to the I/O interface unit and comprising a display panel configured to display a claim identifier for the first healthcare transaction data and the second healthcare transaction data.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and should not be used to delineate or circumscribe the inventive subject matter.

### BRIEF DESCRIPTION OF THE DRAWINGS

FIG. 1 illustrates a general block diagram of a healthcare transaction data management system for tax-advantaged accounts according to an embodiment of a present disclosure.

FIG. 2 illustrates another general block diagram of the healthcare transaction data management system for tax-advantaged accounts according to the embodiment of the present disclosure.

FIG. 3 illustrates a subroutine for managing healthcare transaction data according to the embodiment of the present disclosure.

FIG. 4 illustrates an exemplary user interface depicting a screen shot of a “Broken Ankle” button and associated menu buttons according to another embodiment of the present disclosure.

FIG. 5 illustrates another exemplary user interface depicting a screen shot of a “Broken Ankle” medical problem with a dedicated button and associated menu buttons according to another embodiment of the present disclosure.

FIG. 6 illustrates another exemplary user interface displaying Mint® login interface according to another embodiment of the present disclosure.

FIG. 7 illustrates another exemplary user interface depicting a screen shot of an “import as new records” button and its associated menu buttons according to another embodiment of the present disclosure.

FIG. 8 illustrates another exemplary user interface depicting a screen shot of a list of an event, procedure or condition according to another embodiment of the present disclosure.

FIG. 9 illustrates another exemplary user interface depicting a screen shot of HSA account balances according to another embodiment of the present disclosure.

FIG. 10 illustrates another exemplary user interface depicting a screen shot of HSA funds status according to another embodiment of the present disclosure.

FIG. 11 illustrates another exemplary user interface depicting a screen shot of an expense report according to another embodiment of the present disclosure.

FIG. 12 illustrates another exemplary user interface depicting a screen shot of a claim report according to another embodiment of the present disclosure.

FIG. 13 illustrates a general block diagram of computing unit for managing healthcare transaction data relative to retirement strategy according to another embodiment of the present disclosure.

FIG. 14 illustrates a general block diagram of computing unit for managing healthcare transaction data for determining financial capacity according to another embodiment of the present disclosure.

FIG. 15 illustrates a general block diagram of computing unit for managing healthcare transaction data relative to remote medical assistance according to another embodiment of the present disclosure.

FIG. 16 illustrates another exemplary user interface depicting a screen shot of medical event pictures and associated information to another embodiment of the present disclosure.

FIG. 17 illustrates a general block diagram of computing unit for managing healthcare transaction data with an event tagging to another embodiment of the present disclosure.

FIG. 18 illustrates another exemplary user interface depicting a screen shot of medical event and tagging information to another embodiment of the present disclosure.

FIG. 19 illustrates a general block diagram of computing unit for managing healthcare transaction data for funds deposit within maximum contribution limits to another embodiment of the present disclosure.

FIG. 20 is a flow chart of a method for managing healthcare transaction data according to another embodiment of the present disclosure.

### DETAILED DESCRIPTION

Reference will now be made in detail to embodiments, examples of which are illustrated in the accompanying drawings, wherein like reference numerals refer to the like elements throughout the several views. In this regard, the present embodiments may have different forms and should not be construed as being limited to the descriptions set forth herein. Accordingly, the embodiments are merely described below, by referring to the figures, to explain aspects of the present description. Terms used herein are for descriptive purposes only and are not intended to limit the scope of the disclosure. The terms “comprises” and/or “comprising” are used to specify the presence of stated elements, steps, operations, and/or components, but do not preclude the presence or addition of one or more other elements, steps, operations, and/or components. The terms “first,” “second,” and the like may be used to describe various elements, but do not limit the elements. Such terms are only used to distinguish one element from another.

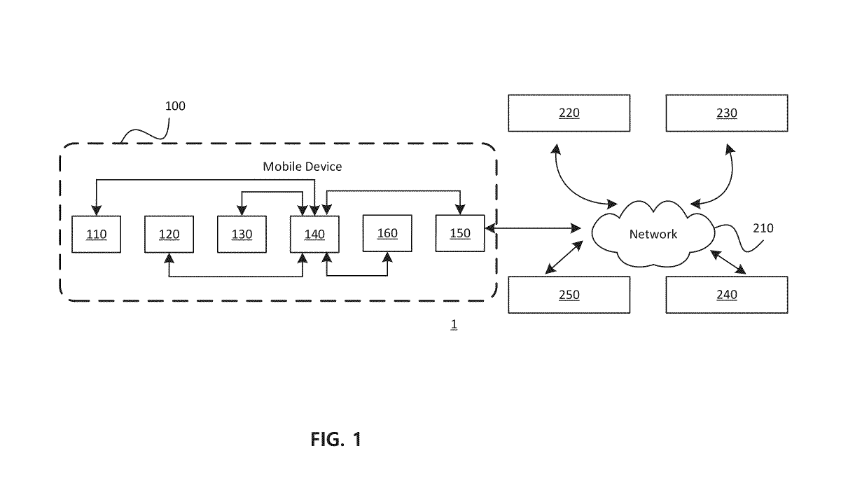

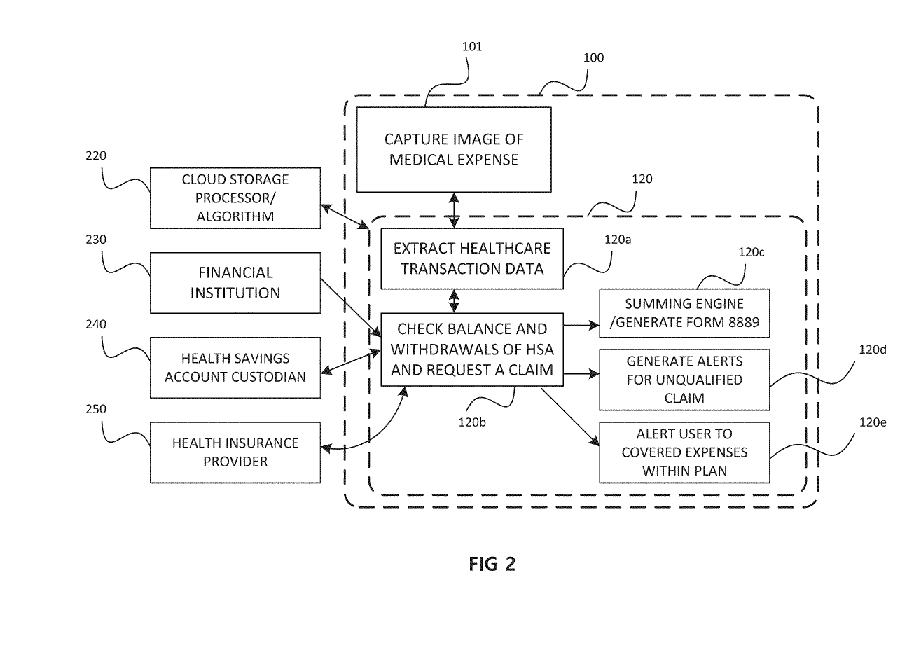

Healthcare transaction data management system 1 contains health education elements for users consuming health products and services e.g., doctor visits, drug purchases, lab tests, and other procedures. An exemplary healthcare transaction data management system 1 for tax-advantaged accounts in accordance with an embodiment of the present disclosure is described herein in FIG. 1. Referring to FIG. 1, each element of healthcare transaction data management system 1 is described. After that, referring to FIG. 2, the operation of a healthcare transaction data management system 1 works is described.

Referring to FIG. 1, healthcare transaction data management system 1 includes a mobile device 100, a network 210, a cloud storage 220, a financial institution 230, a health saving account custodian 240, and a health insurance provider 250.

One or more embodiments of healthcare transaction data management system 1 can include the same or similar components and functionality. In the illustrated embodiment, mobile device 100 includes an image capture unit 110, a computing unit 120, a memory unit 130, an I/O interface unit 140, a network interface unit 150, and a payment unit 160.

Mobile device 100 includes a portable and handheld computing device. Mobile device 100 has a wireless communication capabilities. Mobile device 100 can be connected to internet or Bluetooth-capable devices. Mobile device 100 includes a portable computer device, a smartphone, a tablet computer, and a wearable device including smart watch, smart band, and smart glass. Conventionally, mobile device 100 includes a display screen with input device such as a touch pad, a button, and miniature keyboard. Mobile device 100 has an operating system (OS) and can run various types of application software.

In one embodiment of the present disclosure, mobile device 100 runs a mobile application for managing healthcare transaction data for tax-advantaged accounts. The mobile application runs on any mobile operating system (OS) such as, but not limited to: Android; Windows Mobile; Series40 (S40); Sailfish; or iPhone OS.

Healthcare transaction data management system 1, as described in FIGS. 1-3, is implemented as a mobile application (“app”). The mobile application can be downloaded, installed and/or run on mobile device 100. Healthcare transaction data management system 1, as described in FIGS. 1-3, is implemented as the mobile application.

Those skilled in the art will appreciate that mobile device 100 is merely illustrative and is not intended to limit the scope of the present invention. In particular, the mobile device 100 can include any combination of hardware or software that can perform the indicated functions, and includes portable computers, network devices, internet appliances, PDAs, wireless phones, pagers, Google Glass®. Mobile device 100 may also be connected to other devices that are not illustrated. In addition, the functionality provided by the illustrated components may in some embodiments be combined in fewer components or distributed in additional components. Similarly, in some embodiments, the functionality of some of the illustrated components may not be provided and/or other additional functionality may be available.

Image capture unit 110 includes a conventional image capture apparatus e.g., a digital camera. Image capture unit 110 is configured to capture a single image or multiple images of medical expenses e.g., a medical receipt and other documentation. Healthcare transaction data e.g., amount of medical bill, date, and transaction details, can be extracted from the image at computing unit 120 or cloud processor (not shown) in cloud storage 220. Extracted healthcare transaction data can be stored either in memory unit 130 or cloud storage 220, or both.

Image capture unit 110 can be omitted from mobile device 100. In such case, mobile device 100 can be configured to receive an image of medical expense from other devices via a wireless connection. For instance, a smart band, which lacks an image capture apparatus, can receive the image of medical expense from a smart phone, which is configured to capture such image and transmits the same to the smart wearable device via a wireless connection. The smart wearable device can manage healthcare transaction data for storing and performing predetermined functions.

Computing unit 120 is coupled to memory unit 130 via I/O interface unit 140. Mobile device 100 further includes a network interface unit 150 coupled to I/O interface unit 140.

Computing unit 120 can include any suitable processor capable of executing instructions. For example, in various embodiments, computing unit 120 is a general-purpose or embedded computing unit implementing any of a variety of instruction set architectures (ISAs), such as the x86, PowerPC, SPARC, or MIPS ISAs, or any other suitable ISAs. In multiprocessor systems, computing unit 120 may commonly, but not necessarily, implement the same ISAs. Computing unit 120 is configured to manage healthcare transaction data in a predetermined manner. According to a predetermined set of instructions, for example, computing unit 120 can extract qualified medical expenses from memory unit 130 or cloud storage 220. These expenses can include without limitation: costs of doctor visits; lab visits; pharmacy receipts; flu shot receipts; etc. Computing unit can also forecast the future value of the expenses should the user elect to retain the balance in the Health Savings Account and not withdraw, therefore allowing the amount to acculuate in value given a user's investment selectin (e.g. stock and bond mutual funds, money market accounts, etc). Computing unit 120 then can calculate how much the user could be reimbursed from HSAs.

Memory unit 130 is configured to store program instructions and/or data accessible by computing unit 120. In various embodiments, the memory unit 130 is any type of medium that can stores programs (sequences of instructions) or data on a temporary or permanent basis for use in a digital electronic device. The memory unit 130 can include, for example, Random-Access Memory (RAM), Dynamic Random-Access Memory (DRAM), Static Random-Access Memory (SRAM), Read Only Memory (ROM), Programmable Read-Only Memory (PROM), Erasable Programmable Read Only Memory (EPROM), Electrically Erasable Programmable Read-Only Memory (EEPROM) type memory or tape, magnetic disc or optical discs (CD-ROM and DVD ROM), synchronous dynamic RAM (SDRAM), nonvolatile/Flash-type memory, or any other type of data storage device or memory. In the illustrated embodiment, program instructions and data implementing desired functions, such as those described regarding mobile application are stored within memory unit 130.

Memory unit 130 is configured to maintain first healthcare transaction data and second healthcare transaction data. The first healthcare transaction data are data received from at least one of image capture unit 110 in a user's mobile device 100, a payment unit 160 in the user's mobile device 100, and a manual input from the user. The second healthcare transaction data are data received from financial institution 230 as described hereinbelow. Program instructions and/or data may be received, sent or stored upon different types of computer-accessible media or on similar media separate from memory unit 130 or mobile device 100. Generally speaking, a computer-accessible medium may include storage media or memory media such as magnetic or optical media attachably coupled to or mounted on mobile device 100. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface unit 150.

In some embodiments, program instructions and data implementing a mobile application, as described herein, may be stored within memory unit 130; and/or the mobile application may be a module of memory unit 130. In other embodiments, program instructions and data implementing a comprehensive mobile application may be stored in memory on a separate computing system.

I/O interface unit 140 is configured to coordinate I/O traffic between computing unit 120, memory unit 130, and any peripheral devices in the system or device, including network interface unit 150 and payment unit 160. In some embodiments, I/O interface unit 140 performs any necessary protocol, timing or other data transformations to convert data signals from one component (e.g., memory unit 130) into a format suitable for use by another component (e.g., computing unit 120). In some embodiments, I/O interface unit 140 includes support for devices attached through various types of peripheral buses, such as a variant of the Peripheral Component Interconnect (PCI) bus standard or the Universal Serial Bus (USB) standard, for example. In some embodiments, the function of I/O interface unit 140 may be split into two or more separate components, such as a north bridge and a south bridge, for example. Also, in some embodiments some or all of the functionality of I/O interface unit 140, such as an interface to memory unit 130, is incorporated directly into computing unit 120. In some embodiments, I/O interface unit 140 is configured to receive a user input of healthcare transaction data via manually operated text entry tool.

I/O interface unit 140 can execute a user interface (not shown in FIGS. 1 and 2) to allow the user to interact with healthcare transaction data management system 1. The user interface allows the user to perform various actions or activities associated with healthcare transaction data management system 1. The user interface is displayed to the user in a different format depending on the type of operating system (OS) or requirement of mobile device 100. For example, the different formats can include different computer program languages including XML, HTML, CSS, JavaScript, plaintext and Java.

Network interface unit 150 is configured to allow data to be exchanged between mobile device 100 and other computing systems attached to a network 210. In other embodiments, network interface unit 150 is configured to allow data to be exchanged between nodes of mobile device 100. In various embodiments, network interface unit 150 supports communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol. In one embodiment, network interface unit 150 uses standard communications technologies and/or protocols. Network interface unit 150 can include links using technologies such as Ethernet, IEEE 802.11, worldwide interoperability for microwave access (WiMAX), such as 5G, 4G LTE (long term evolution), LTE-A, 3G (UMTS FDD and TDD, CDMA2000 1×EVDO, CDMA2000 3×, TD-SCDMA, Arib WCDMA, EDGE, IMT-2000 DECT), 2G (GSM, CDMAOne, D-AMPS), 1G (NMT, C-Nets, AMPS, TACS), Wi-Fi, Bluetooth, GPS (Global Positioning System), NFC (Near Field Communication), digital subscriber line (DSL), asynchronous transfer mode (ATM), InfiniBand, PCI Express Advanced Switching, and any present or future technology the like.

Input/output devices (not shown) may, in some embodiments, include one or more display screen and touchpads or any other devices suitable for entering or retrieving data by one or more mobile device 100.

A payment unit 160 is located at the user's mobile and is configured to make mobile payments with a near field communications (NFC) reader device. Payment unit 160 is coupled to computing unit 130 via I/O interface unit 140. Payment unit 160 in the user's mobile device can be omitted from mobile device 100. In such case, mobile device 100 can be configured to receive such healthcare transaction data from other sources via a wireless connection. Payment unit 160 works as a digital wallet service such as Apple Pay® by Apple Inc. Payment unit 160 allows the user to make payments using mobile device 100. Payment unit 160 does not require specific contactless payment terminals and is configured to work with various conventional contactless payment terminals including Visa's PayWave, MasterCard's PayPass, and American Express's ExpressPay terminals.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated mobile device via inter-computer communication. Some or all of the system components or data structures are also stored (e.g., as instructions or structured data) on a computer-accessible medium or a portable article to be read by an appropriate drive, various examples of which are described above. In some embodiments, instructions stored on a computer-accessible medium separate from mobile device 100 are transmitted to mobile device 100 via transmission media or signals such as electrical, electromagnetic, or digital signals, conveyed via a communication medium such as a network and/or a wireless link. Various embodiments further include receiving, sending or storing instructions and/or data implemented in accordance with the foregoing description upon a computer-accessible medium.

Note that the user interface mechanisms and elements as illustrated and described are exemplary and are not intended to be limiting, and various modifications to or variations of the mechanisms and elements are possible, as are alternative user interface mechanisms and elements that are configured to perform similar functions.

Network 210 is a conventional computer network that is a telecommunications network for allowing mobile device 100 and other devices to exchange data. Data is transferred in the form of packets. Network 210 includes an internet that has a global system that use the standard Internet protocol suite (TCP/IP) to link several billion devices worldwide. The network links between nodes can be established with either cable media or wireless media.

Cloud storage 220 is a conventional web based data storage which is configured to be accessed through a web service application programming interface (API) by applications that utilize the API or any similar integration or data sharing technology. Cloud storage 220 allows the user to store, synchronize and share electronic files online with the user or a third party in a predetermined manner. Healthcare Cloud storage 220 receives healthcare transaction data in an electronic form from various sources via internet, stores the data online and retrieves them on demand at any time. The user can use a password or conventional security tools to access the data on the cloud storage 220. Mobile device 100 can access cloud storage 220 via network, and according to a predetermined manner, mobile device 100 can store electronic data either in cloud storage 220 or memory unit 130, or both. Cloud storage 220 includes a cloud processor (not shown) or an algorithm (not shown). Cloud processor (not shown) or algorithm (not shown) is configured to manage healthcare transaction data in a predetermined manner. For instance, cloud processor (not shown) can manage healthcare transaction data for qualified medical expenses, such as doctor visits, lab visits, pharmacy receipts, flu shot receipts, etc. and calculate how much the user could reimburse from HSAs.

Financial institution 230 refers to an institution that has financial data of the user including credit or debit card use and transaction details thereof. Financial institution 230 can have an aggregated financial data of the user from a single financial institution or multiple financial institutions at which the user has an account. For example, financial institution 230 can refer to a bank at which the user has an account or an online financial aggregation service provider, e.g., www.mint.com®, to scrape financial transaction data from a plurality of financial sources so as to track all of bank, credit card, investment, and loan transactions. Financial institution 230 transmits financial transaction data of the user to mobile device 100 or cloud storage 220 via network 210.

As mentioned above, Health insurance custodian 240 refers to the administrator of a financial arrangement. For instance, a user can start HSAs with banks, brokers, credit unions, and insurance companies. Any company that the user opens and uses HSAs can be referred to as Health Insurance Custodian 240.

Health insurance provider 250 refers to conventional insurance companies which provide a medical insurance covering the cost of medical treatments. In particular, Health insurance provider 250 can provide a high-deductible health plan (HDHP). An HDHP is a health plan that satisfies specific IRS design requirements that allows the user to make or receive HSAs contributions if other eligibility criteria are also satisfied.

Health Savings Accounts (HSAs) are tax-advantaged medical savings account available to taxpayers in the United States who are enrolled in a High-Deductible Health Plan (HDHP). HSAs have become increasingly popular financial account vehicles due to the growth in qualified HDHP or Consumer-Driven Health Plans (CDHP). Health consumers need to be enrolled in a qualified HDHP to open an HSA, though they are not obligated to do so.

HSAs carry many advantages. For instance, the Internal Revenue Service (IRS) allows for a “triple tax advantage” to HSAs. First, the funds are deposited from payroll on a pre-tax income basis. Secondly, the funds are pre-payroll tax which saves both employee and employer on payroll taxes. Lastly, the funds are withdrawn tax-free for qualified medical expenses, both basis (original deposit amount) and any gains (growth) on the principal. A user's qualified medical expenses/receipts can be cumulative over the course of a working employee's career, provided the consumer was enrolled in a HDHP at the time the expense was incurred. This enables a “new” savings strategy whereby a user can invest a portion or all of their HSA deposits and grow the balance through interest or market appreciation of the security (e.g. mutual funds or other brokerage account).

HSAs are different financial instruments from traditional flexible savings accounts (FSAs). FSAs have relatively lower annual contribution limits. Further, FSA funds not used by the end of the plan year in are forfeited, known as the “use it or lose it” rule. Conversely, HSAs balance roll over year to year, accumulating in a user's account. FSAs are contained within debit accounts that builds relatively lower interest. HSAs can accumulate inside market securities (mutual funds, stocks, bonds, etc.), as well as retain traditional debit card functionality similar to FSA's. As one of retirement strategies, individuals can consider accumulating retirement savings first inside HSAs. HSAs therefore can function as both short term and long-term savings vehicles, provided the user is aware of these features and elects to manage the account in this fashion.

The IRS rules, which govern HSAs, allow HSA users to take much more control over their health interactions. However, to meet the IRS requirements, a user of HSAs needs to keep qualified medical expense tracking and documentation of current and future health care expenses. This may create an administrative buden as individuals often find it difficult to manage and maintain a volume of health expenses and receipts needed to verify appropriate reimbursements from HSAs. Furthermore, as employees change employers or as employers change health plans periodically, both of which are projected to occur with increasing frequency, it is not easy for the user to keep and manage all medical receipts in an account the user controls.

In order to obtain the maximum theoretical benefits from HSAs, the user should keep up with these cumulative receipts and develop a “saving and claiming” strategy associated with their own qualified medical expenses and the growth of personal retirement funds inside HSAs. Accordingly, a new way of managing and storing medical transaction data is needed.

Certain terms are used in describing exemplary embodiments with respect to drawings. The following descriptions are provided for these terms. These descriptions are provided to help explain these terms as used in the descriptions below but are not to be taken as necessarily limiting the scope of the disclosed embodiments. A user refers to the individual owning or controlling the assets held in a Health Savings Account (HSA) or the beneficiary of a financial arrangement. Health Savings Account Custodian refers to the financial institution holding the assets in a limited-purpose tax-advantaged account or the administrator of a financial arrangement. Tax-advantaged account refers to a financial account or arrangement which confers tax benefits on money designated for specific expenditures such as health care. Tax benefits may include payroll and/or income tax-free contributions, tax-free growth, and/or tax-free withdrawals. Reimbursement refers to a method for making withdrawals from tax-advantaged accounts whereby the health savings account custodian disburses funds in a lump-sum to another account rather than directly to a qualifying supplier.

Qualifying expense refers to an expenditure for goods or services for the benefit of a user or other authorized beneficiary which meets the guidelines specified by the IRS and other authorities for payment from HSAs. Withdrawal refers to money removed from HSAs which conform to account usage guidelines specified by the IRS, and is not subject to a tax penalty. Transaction refers to the electronic report of an expenditure received directly by the system from either a health savings account custodian or other financial institution which an user uses to make payments. The user may designate a transaction as a qualifying or non-qualifying expense.

Now, embodiments for healthcare transaction data management system 1 for tax-advantaged accounts, such as Health Saving Accounts (HSAs), are described herein with respect to the drawings. Healthcare transaction data management system 1 is designed for storing a user's healthcare transaction data for medical expenses, such as doctor visits, lab visits, pharmacy receipts, flu shot receipts, etc. in one electronic device in a digital format. In addition, a user can store other health data such as shot records, drugen warning labels (often provided by pharmacy at time of dispensing prescription), hospital contact info, and other information useful to managing one's health “life.” Healthcare transaction data management system 1 uses the healthcare transaction data to determine how much the user could reimburse from HSAs and allows the user to keep track of receipts and payments for qualified medical expenses, and related documentation such as an electronic Explanation of Benefits (“EOB”) and provider billings and/or credit card statements. In addition, healthcare transaction data management system 1 stores images of receipts which can later be used for tax documentation of HSA withdrawals, and enable the user to make health savings account investments as a part of his/her retirement strategy.

The particular embodiment of the present disclosure will be described hereinafter in greater detail referring to FIG. 2. FIG. 2 illustrates an exemplary general block diagram for managing healthcare transaction data for tax-advantaged accounts according to the embodiment.

In a first step 101, user uses mobile device 100 to capture an image of a medical expense 101. Captured image is transmitted to computing unit 120. Computing unit 120 extracts a first healthcare transaction data 120a from the image. First healthcare transaction data 120a includes, for instance, an amount of medical bill and transaction details. Computing unit 120 determines whether the first healthcare transaction data includes eligible medical expenses as described in Section 213(d) of the Internal Revenue Service Tax Code. Computing unit 120 keeps qualified medical expense tracking and stores the results either in memory unit 130 or cloud storage 220.

Eligible medical expenses may include Acupuncture, Alcoholism, Ambulance, Annual Physical Examination, Artificial Limb, Artificial Teeth, Autoette, Bandages, Birth Control Pills, Body Scan, Braille Books and Magazines, Breast Pumps and Supplies, Breast Reconstruction Surgery, Capital Expenses, Car, Chiropractor, Christian Science Practitioner, Contact Lenses, Crutches, Dental Treatment, Diagnostic Devices, Disabled Dependent Care Expenses, Drug Addiction, Drugs, Eye, Exam, Eyeglasses, Eye Surgery, Fertility Enhancement, Founder's Fee, Guide Dog or Other Service Animal, Health Institute, Health Maintenance Organization (HMO), Hearing Aids, Home Care, Home Improvements, Hospital Services, Insurance Premiums, Intellectually and Developmentally Disabled, Special Home for, Laboratory Fees, Lactation Expenses, Lead-Based, Paint Removal, Learning Disability, Legal Fees, Lifetime Care Advance Payments, Lodging, Long-Term Care, Meals, Medical Conferences, Medical Information Plan, Medicines, Home, Nursing Services, Operations, Optometrist, Organ Donors, Osteopath, Oxygen, Physical Examination, Pregnancy Test Kit, Prosthesis, Psychiatric Care, Psychoanalysis, Psychologist, Special Education, Sterilization, Stop-Smoking Programs, Surgery, Telephone, Television, Therapy, Transplants, Transportation, Trips, Tuition, Vasectomy, Vision Correction Surgery, Weight-Loss Program, Wheelchair, Wig, and X-ray, and other items as the IRS may allow from time to time per published guidelines.

Computing unit 120 is configured to receive second healthcare transaction data from financial institution 230. When computing unit 120 receives the second healthcare transaction data, the second healthcare transaction data can be aggregated financial data of the user from one or multiple financial institutions at which the user has an account. After computing unit 120 receives the second healthcare transaction data, computing unit 120 determines whether the second healthcare transaction data includes eligible medical expenses in accordance with Section 213(d) of the Internal Revenue Service Tax Code as described above.

Computing unit 120 is configured to compare the first healthcare transaction data and the second healthcare transaction data to check whether there is overlapped transaction information. For instance, when the user uses a credit card at a pharmacy to purchase a drug and captures the receipt with his/her mobile device 100, both of the first and second healthcare transaction data include the same transaction data. That is because image capture unit 110 captures the receipt and transmits the receipt information to computing unit 120 with the first healthcare transaction data, and the credit card transaction information is stored in financial institution 230 and is transmitted to computing unit 120 with the second healthcare transaction data. In such case, only one healthcare transaction can be counted by computing unit 120 for further medical expense calculation purpose.

Referring to FIG. 2, computing unit 120 is also configured to check a balance and withdrawals of HSAs, and to submit a claim request documentation 120b. The user can request disbursements from HSAs if the user has HSAs at the time of the qualified expense. The user needs to submit the healthcare transaction data e.g., date and amount and to keep electronic copies of any available supporting documentation related to the transaction as documentary support for the requested disbursement.

Healthcare transaction data management system 1 is configured to generate a claim request documentation, which includes healthcare transaction data, e.g., date and amount, and is configured to submit the claim request documentation to either health saving account custodian 240 or health insurance provider 250.

The user can request reimbursement from HSAs by using a debit card or a credit card associated with HSAs as well. Debit or credit card transaction data is automatically or manually stored at least one of memory unit 130 and cloud storage 220 as a part of the second healthcare transaction data.

The IRS may require that he user prove that all reimbursements taken from HSAs were for eligible expenses. Thus, the user needs to retain the supporting documentation with the tax information for a predetermined number of years, as the IRS rules regulate, e.g., seven (7) years. Healthcare transaction data management system 1 is configured to store the supporting documentation either in memory unit 130 and/or cloud storage 220 in an electronic format for the predetermined years or permanently. The supporting documentations stored by healthcare transaction data management system 1 includes an electronic Explanation of Benefits (“EOB”) from a health insurance carrier, a health claims third party administrator (“Health TPA”), a pharmacy benefit manager (“PBM”), bill or receipt, a description of the item or service, the name of the store or provider and the amount the user paid.

According to IRS rules, the user of HSAs is required to prepare Form 8889 with the user's tax return. The purpose of the form is to report the user's deductible contributions, calculate the deduction, report the distributions the user takes to pay medical expenses and to calculate the tax the user must pay on withdrawals the user makes for non-medical related purposes.

Again referring to FIG. 2, computing unit 120 is configured to extract necessary data from either memory unit 130 or cloud storage 220 and process the data to generate an IRS Form 8889 as depicted in step 120c. The necessary data to complete the Form 8889 includes, for instance, HSA contributions the user and the user's employer made in a given year, qualified HSA funding distributions, and the user's date of birth. The necessary data to complete the Form 8889 can further include information whether the user's coverage under a high-deductible health plan (HDHP) in a given year is covered by a self-only HDHP or by a family HDHP, or whether the user is filing jointly and both the user and the user's spouse each have separate HSAs. Thus, Healthcare transaction data management system 1 is configured to receive such necessary information from the user, memory unit 120, or cloud storage 220. Upon the user's instruction, healthcare transaction data management system 1 is configured to generate Form 8889 in an electronic format, e.g., PDF or any other electronic format that is suitable for submission to IRS.

Still referring to FIG. 2, computing unit 120 is configured to generate alerts for unqualified claims to the user as depicted in step 120d. Alerts can be delivered as voice, sound, e-mail, text, instant messages, displayed message on the screen of the mobile device 100 and other multi-media formats. The alert can include information indicating the nature, urgency, and/or expected response of messages. The user can change the settings according the user's preference.

Computing unit 120 is also configured to generate alerts for uncovered expenses within the plan in step 120e. Healthcare transaction data management system 1 is configured to transmit alerts or reminders to the user to submit a claim request documentation for uncovered expenses within plan.

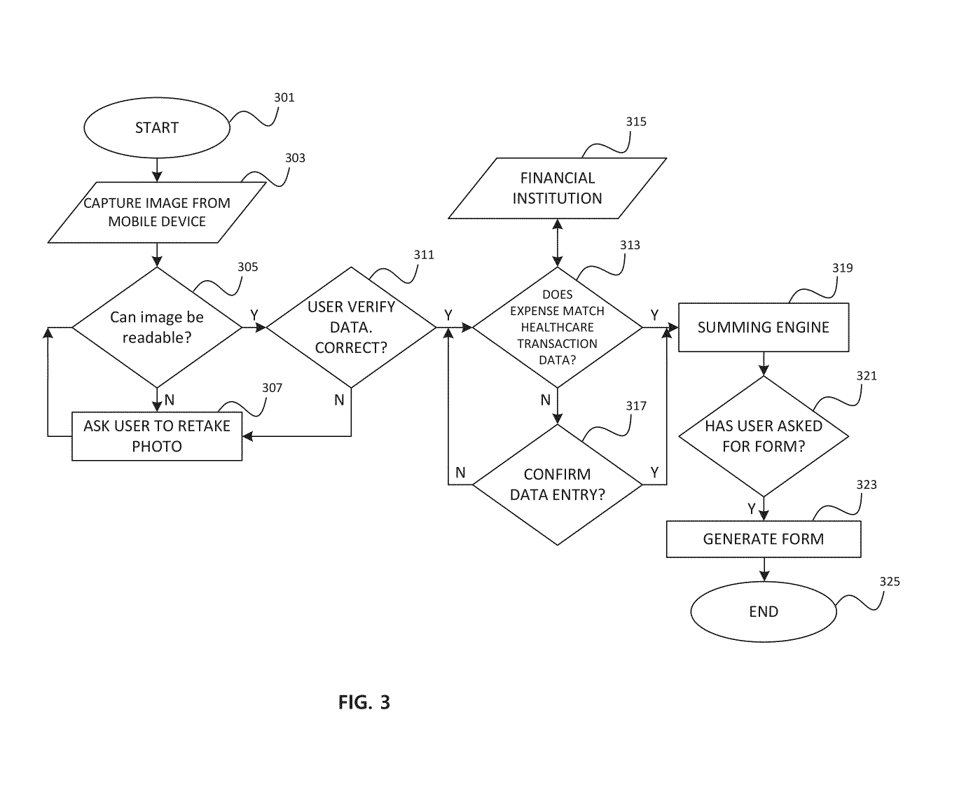

With reference now to FIG. 3, a subroutine for managing healthcare transaction data according to another embodiment by the mobile application is described. The subroutine begins at a start terminal 301 and proceeds to an input step 303 where image capture unit 110 captures an image of receipt. From step 303, the mobile application proceeds to a decision step 305 where it is determined if the image is readable and healthcare transaction data can be extracted therefrom. Computing unit 120 is configured to include an optical character recognition (OCR) software and is configured to convert the image into a machine-encoded text. Extracted text information can be saved in memory unit 130 and analyzed and organized by a computer program on the mobile device.

Hereinafter the extracted healthcare transaction data is referred to as a first healthcare transaction data. If the image is readable and the first healthcare transaction data is extracted, then the mobile application proceeds to a decision step 311 where a verification is made by the user if the first healthcare transaction data is correct. At step 305, if the image is unreadable and the first healthcare transaction data is not properly extracted, then the mobile application proceeds to a process step 307 where the user is asked to retake the image and loops to the top of step 305 until the image is readable. If the user does not desire to use the image, the user can skip step 305 and proceed to step 311.

At step 311, if the user verifies that the first healthcare transaction data is correct, then the mobile application proceeds to a decision step 313 where the first healthcare transaction data matches a second healthcare transaction data received from financial institution 230. If the user skipped step 305, the user can be asked to manually input an amount of the receipt.

An input step 315 is a step where the second healthcare transaction data are aggregated financial data of the user from one or multiple financial institutions at which the user has an account. Step 313 and step 315 can be concurrently executed and proceed back and forth to exchange the data. If the user uses either credit or debit card for medical expenses, the first healthcare transaction data match the second healthcare transaction data, then the mobile application proceeds to a process step 319. If the user uses cash for medical expenses and the first healthcare transaction data do not match the second healthcare transaction data, then the mobile application proceeds to a decision step 317. At step 317, the user is asked to confirm the data entry, that is whether the data entry is correct or whether cash is used. If the data entry is properly made, then the mobile application proceeds to a process step 319. If the data entry is not properly made, then the mobile application loops back to the top of step 313.

At step 313, there are three possible combinations as to how the medical expense data are gathered: 1) both of credit/debit card data and receipt thereof captured from image capture unit 110, 2) credit/debit card data from financial institution 315, and 3) cash receipt from image capture unit 110.

For instance, if the user visits CVS and buys $15 for medical medicine and $10 for tabacco, a total price of transaction is $25.

1) Using Both of Credit/Debit Card Data and Receipt Captured from Image Capture Unit 110

If the user uses a credit card, the transaction information is sent to financial institution 315, e.g., Mint® or bank account. If a user takes a picture of the transaction receipt, image capture unit 110 captures an image of the transaction. In this instance, the total amount of the receipt is $25, and at step of 305, OCR extracts the total amount of price and two itemized transactions: $15 for medical medicine and $10 for tabacco. Financial institution 315, e.g., Mint® is configured to communicate with mobile device 100 and provides all transaction data information thereto including the two itemized transactions. At step 313, the computing unit receives first healthcare transaction data from image capture unit 110 and second healthcare transaction data from financial institution 315. With respect to the first health transaction data from image capture unit 110, at step 313, computing unit 120 decides that $10 for tabacco should not be considered for medical expense but only $15 for medical medicine. Regarding second health transaction data from financial institution 315, the computing unit 120 performs the same process. Then, at step 313, computing unit 120 determines whether the medical expense of first health transaction data matches that of second health transaction data. If it matches, the process proceeds to step 319 and if it does not match, it loops to step 317.

2) Credit/Debit Card Data from Financial Institution 315

If a user does not take a picture of the transaction receipt, there is no input to image capture unit 110. In this situation, Financial institution 315, e.g., Mint® provides all transaction data to mobile device 100. At step 313, computing unit 120 decides whether each of the transaction items should be regarded as a medical expense in accordance with a predetermined rule. Thus, computing unit 120 decides that the $15 for medical medicine is considered for further process in mobile application and the process proceeds to step 319. If there are no matched medical expense, it loops to step 317.

3) cash receipt from image capture unit 110

If a user uses only cashes for this transaction, there is no input to financial institution 315. In this situation, at step 313, computing unit receives the transaction data from image capture unit 110. At step 313, computing unit 120 decides that $15 for medical medicine is considered for further process and the process proceeds to step 319. If there are no matched medical expense, it loops to step 317.

At step 319, computing unit 120 calculates and processes healthcare transaction data to obtain a result the user requested. For instance, computing unit 120 is configured to gather qualifying medical expense. The mobile application proceeds to a decision step 321 to decide whether there is a request from the user to generate necessary form, e.g., Form 8889. Upon receipt of such instruction from the user, the mobile application proceeds to a process step 323 to generate the requested form. The subroutine process terminates in terminal 325.

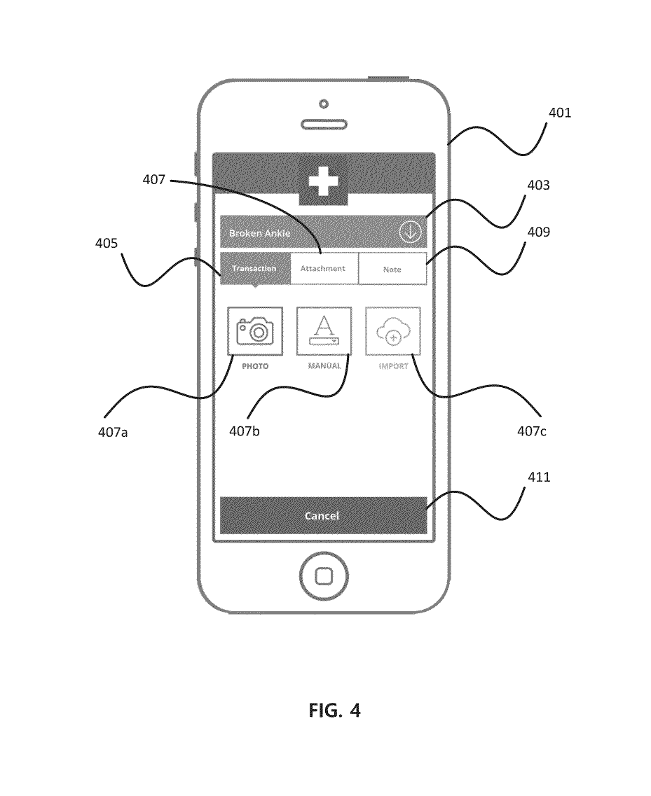

With reference now to FIGS. 4-12, exemplary user interfaces for different situations that can be provided by mobile application according to the embodiment will be described. Healthcare transaction data management system 1 as described with reference to FIGS. 1 to 3, is implemented as the mobile application. Exemplary user interfaces as depicted in FIGS. 4-12 illustrate example screenshots on mobile device 100 of the screen after executing the mobile application.

Referring to FIG. 4, an exemplary user interface 401 depicts a screen shot of a “Broken Ankle” button 403 and its associated menu buttons. The mobile application presents a button or active link on the display screen. Displayed button or active link on the screen of mobile device 100 can include a web URL address or a link to a predetermined page within the mobile application. The mobile application is capable of performing a predetermined function as the users press, tap, tap and hold, pinch or stretch, rotate, slide to scroll, slide to rearrange, or swipe the button, active link, or any visual presentation on a screen of the mobile device 100.

“Broken Ankle” button 403 is an exemplary medical event, procedure or condition. The user can freely modify the title of “Broken Ankle” button 403 or create a new entry button. A “Transaction” button 405, an “Attachment” button 407, and a “Note” button 409 are displayed underneath the “Broken Ankle” button 403. When the user taps “Transaction” button 405, the user can check the financial transaction details in HSAs. When the user taps “Attachment” button 407, the user is able to import data onto memory unit 130 or cloud storage 220 from various sources including USB, online data originator, etc. When the user taps “Note” button 409, a digital notebook is opened so that the user can use to-do lists, and meeting notes after doctor's visit, next visit plans, or anything the user wants to organize or remember. The user is allowed to type or jot down notes, record audio or snap a picture and the note function can save it. Contents of note can be synchronized with cloud storage 220.

A “Photo” button 407a, a “Manual” button 407b, and an “Import” button 407c are displayed in the middle of the screen in a row along with icons for receiving inputs. When the user taps “Photo” button 407a, image capture unit 110 is activated and takes a picture of medical expense. When the user hits “Manual” button 407b, the user is able to input data manually. The user can manually make healthcare transaction data entry onto healthcare transaction data management system 1. When the user presses “Import” button 407c, an importing data dialog displays available data files. If the user sets the default file type in advance, available files in a default type format will be displayed. The importing data can include, for instance, xls, xlsx, csv, tsv, ods, ds type files. A “cancel” button 411 is displayed on the bottom of the screen.

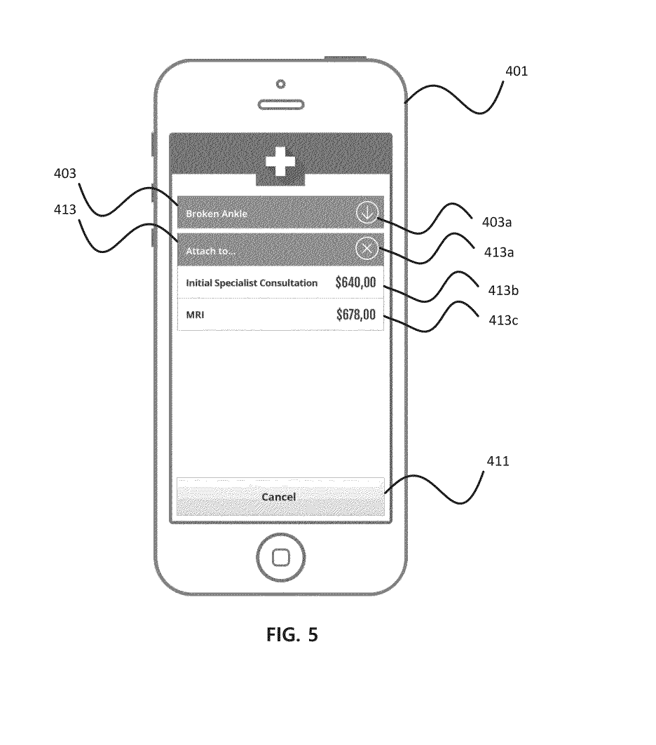

Referring to FIG. 5, another exemplary user interface 401ⁱ depicts a screen shot of a “Broken Ankle” button 403 and its related menu buttons. “Broken Ankle” button 403 includes, for instance, a drop-down menu button 403a. When the user hits the drop-down menu button 403a, the mobile application displays any medical expenses or actions associated with “Broken Ankle” event. If the user hits an “Attached to” button 413, it shows healthcare transaction data 413b and 413c that are attached, drop-down folding button 413a is located within “Attached to” button 413. Healthcare transaction data 413b includes an item name of medical expense such as “initial specialist consultation” and amount of “$640.00.” Another healthcare transaction data 413c displays an item name of medical expense such as “MRI” and amount of “$678.00.”

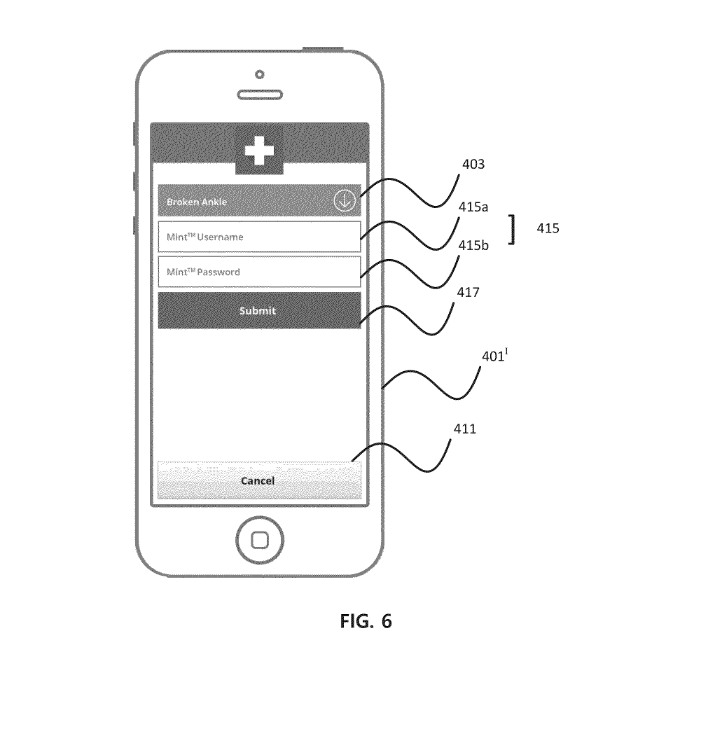

Referring to FIG. 6, another exemplary user interface 401ⁱⁱ displays Mint® login interfaces. As described in FIGS. 1-3, mobile device 100 exchanges data with financial institution 230, e.g., Mint®. Mint® login interfaces asks the user to provide login information 415. Login information 415 includes a username 415a and a password 415b. After the login information 415 is provided, the user hits a “Submit” button 417 so that the mobile application can have an access to database of financial institution 230 (FIG. 1).

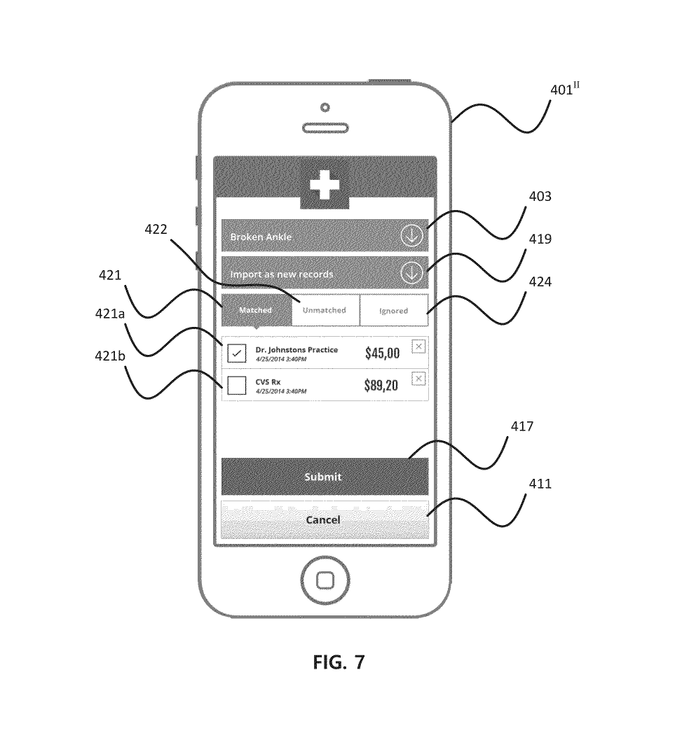

Referring to FIG. 7, another exemplary user interface 401ⁱⁱⁱ depicts a screen shot of an “import as new records” button 419 and its associated menu buttons. The mobile application is configured to import financial data either from financial institution 230 or an image captured from the image capture unit 110. According to a predetermined criteria, the mobile application is configured to classify the imported financial data into, for instance, “Matched” 421, “Unmatched” 422, and “Ignored” 424. “Matched” button 421, “Unmatched” button 422, and “Ignored” button 424 are displayed underneath “Import as new records” button 419. Two healthcare transaction data 421a and 421b are displayed underneath “Matched” button 421. Button 421a represents data received from Dr. Johnston Practice and button 421b represents data received from a CVS pharmacy.

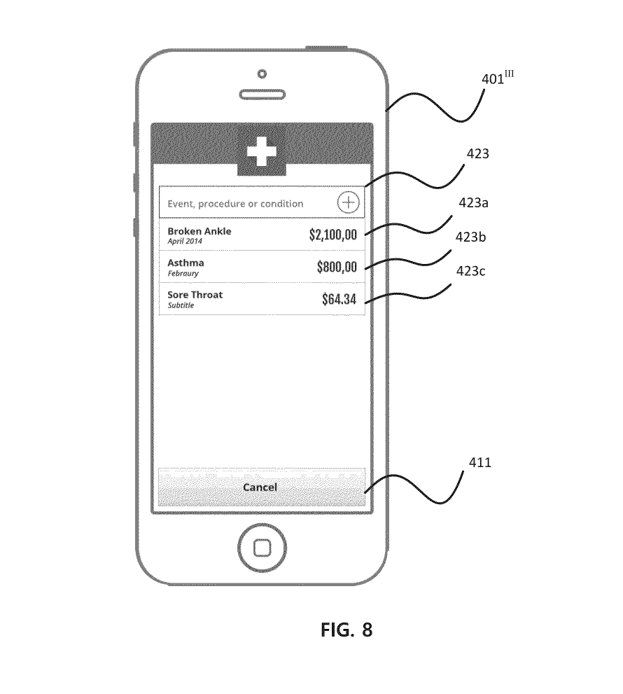

Referring to FIG. 8, another exemplary user interface 401^{iv} depicts a screen shot of a list of an event, a procedure or a medical condition. The user can hit an “Event, procedure or condition” button 423 and add or update any event, procedure or condition thereto. For instance, items including “Broken Ankle” 423a, “Asthma” 423b, and “Sore Throat” 423c are displayed along with respective date and expenses thereof.

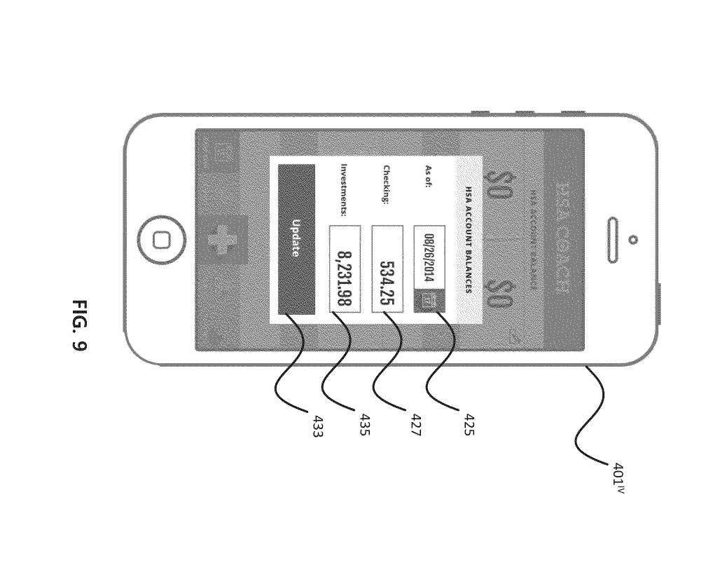

Referring to FIG. 9, another exemplary user interface 401^{v} depicts a screen shot of HSA account balances. The screen shot includes date 425, amount of funds in checking account 427, and amount of funds in investments 435. Mobile application is configured to provide a plurality of services with the user for self-directed investing which includes stocks, bonds and mutual funds. The mobile application provides the user with online access to trading tools, and third-party research. Furthermore, the mobile application can secure online trade confirmations and account statements. In one embodiment, the mobile application can provide ability to set up multiple watch lists. The user can import data manually or automatically by tapping update button 433 any changes to the entry.

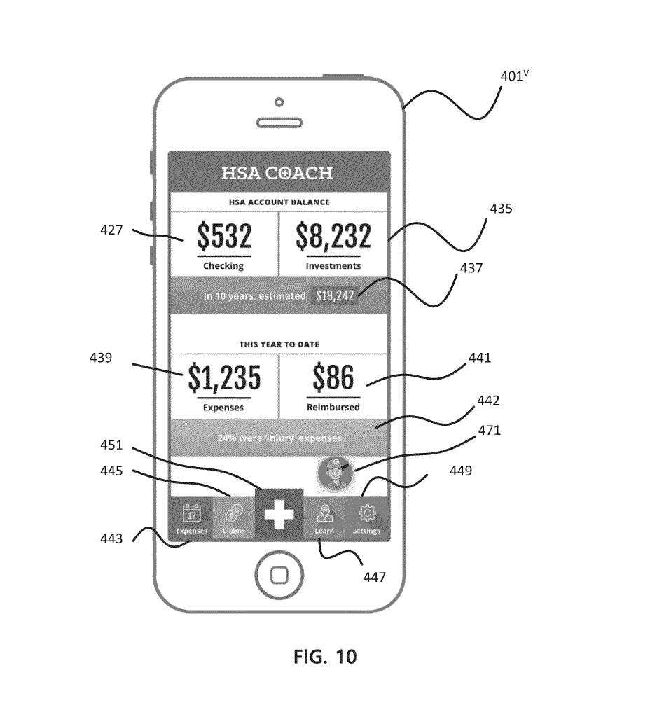

Referring to FIG. 10, another exemplary user interface 401^{vi} depicts a screen shot of HSA funds status. The screen shot includes HSA checking account box 427, HSA investment account box 435, HSA calculator box 437, a total amount of expense to date in a given year box 439, a total amount of reimbursed funds date box 441, and a software agent “Coach Icon” 471.

HSA checking account box 427 displays the total amount of funds that the user has saved. HSA investment account box 435 displays the total amount of funds deriving from HSA investments, for instance, in mutual funds from a variety of fund companies and investment styles.

HSA calculator 437 calculates how much the user can save over time in the user's HSA. For instance, the mobile application collects values for HSA contribution per year, HSA deductible and other qualified medical expenses per year, the years to accumulate, and the user's expected federal tax bracket, state tax rate, and estimated rate of return on the HSA. With a consideration of the values, the mobile application calculates and displays a total amount of money the user can save in HSAs within a predetermined year, e.g., 10 years. Also displayed are total amount of expense to date in a given year in box 439 and the total amount of reimbursed funds in box 441 out of the total amount of expenses. The mobile application is configured to analyze the expenses and display the result in box 442.

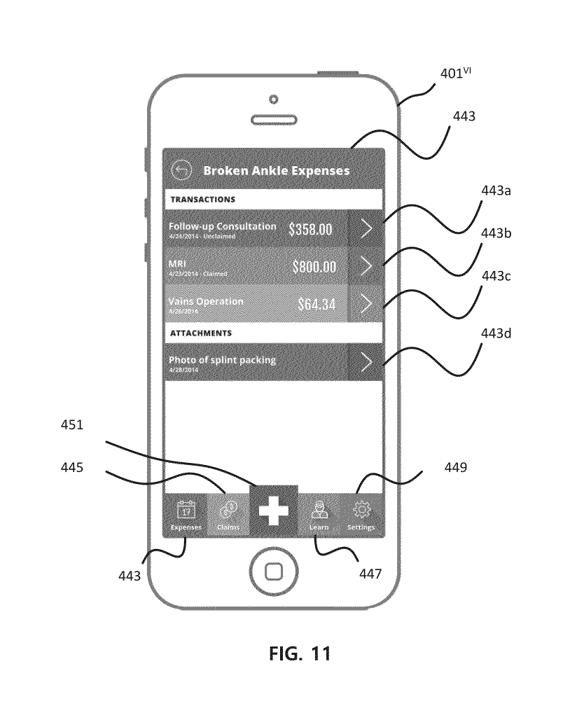

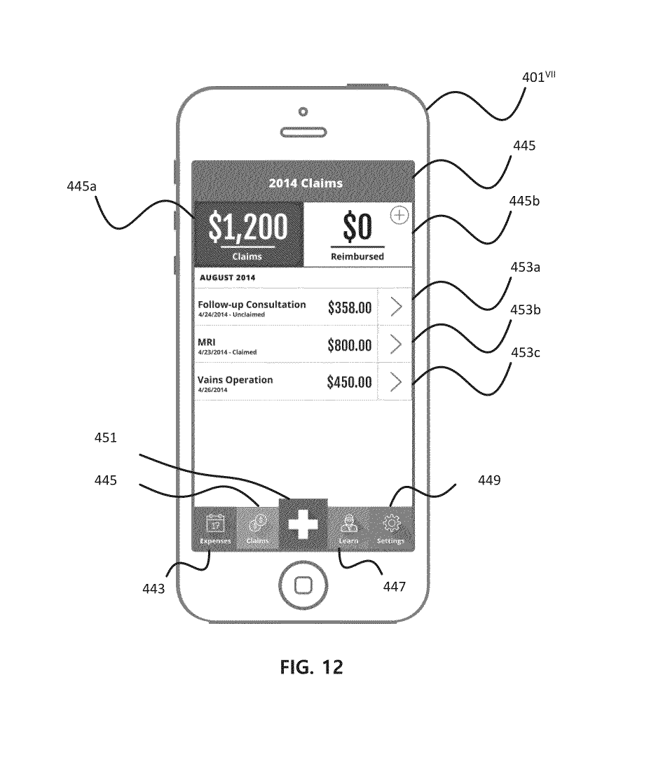

The mobile application is also configured to have an “Expense” button 443, a “Claims” button 445, a “Plus” button 451, a “Learn” button 447, and a “Settings” button 449. If the user taps “Expense” button 443, the mobile application provides an expense report. The expense report is depicted in FIG. 11. If the user taps a “Claims” button 445, the mobile application provides a claim report. The claim report is depicted in FIG. 12. If the user taps a “Plus” button 451, the mobile application produces the results of the amounts of the Expenses and Claims. If the user hits a “Learn” button 447, the mobile application provides a learning module which provides an interactive education session regarding a HSA mechanism, HSA terminologies, etc. Furthermore, the user can have access to a blog, regulations and updated Frequently Asked Questions (FAQ) as well. If the user taps a “Settings” button 449, the user is allowed to modify a various setting in accordance with the user's preferences. For instance, the user can add dependents or spouse to mobile device 120 database. Later, upon the user's request, the user can navigate each of dependents' information and sorts or organizes the information.

A software agent “Coach Icon” 471 is configured to provide detailed description about various actions that mobile application can perform. When the user activates Coach Icon 471, Coach Icon 471 is configured to provide detailed information about requested action. For instance, referring to FIG. 10, Coach Icon 471 is located near to box 442 and if the user activates Coach Icon 471 by clicking thereon, Coach Icon 471 provides the user with an explanation about an action in which the box 442 can execute. Coach Icon is a software agent and is configured to perform in accordance with a predetermined rules. Coach Icon 471 can provide a chatting function so that the user can be communicating with a computer assistant. Coach Icon 471 can also be an animated icon or an “avatar.”

Referring to FIG. 11, another exemplary user interface 401^{vii} depicts a screen shot of an expense report 443. Expense report 443 is configured to be displayed per an event, procedure, or condition. For instance, expense report 443 as depicted in FIG. 11 is related to a broken ankle expenses. Expense report 443 displays a list of healthcare transaction data 453a, 453b, and 453c with amount, date, and claim identifier and any attached files related to the specific event, procedure, or condition.

Referring to FIG. 12, another exemplary user interface 401^{viii} depicts a screen shot of a claim report. The claim report is shown in box 445 and the amount recorded therein includes a total amount of claimed money in a box 445a and a total amount of reimbursed money in a box 445b in a given year, e.g., 2014. Claim report box 445 displays a list of healthcare transaction data in boxes 453a, 453b, and 453c with amount, date, and a claim identifier, e.g., claimed or unclaimed.

If a user selects any period of time or a specific year, the mobile application is configured to generate requested information over the requested period of time including HSAs balance, reimbursement, etc. If the user was enrolled in and out of HSAs over time, the mobile application can display the balance or requested information over time. If the user had qualifying expense and received reimbursement thereof, the mobile application can provide available contribution limits for a given year reflecting the amount of reimbursement made and a reminder of such remaining contribution limits. Referring to Table 1 below, another embodiment of the present disclosure is further described.

TABLE 1

| | Tax year 2012 | Tax year 2013 | Tax year 2014 |
|---|---|---|---|
| Contribution Limit | Individual | Individual | Individual |
| | coverage | coverage | coverage |
| | $3,100 | $3,250 | $3,300 |
| Actual Contribution | $3,100 | | $3,300 |
| by the user | | | |
| Expense | $1,000 | | $500 |
| Available | $1,000 | | $1,500 |
| Reimbursement | | | |

Referring to Table 1, the user is enrolled in High Deductible Health Plans (HDHP) in 2012 and 2014, but was not enrolled in HDHP in 2013. Thus, the user is eligible to make a contribution in HSAs for 2012 and 2014 only. If the user requests a total amount of contribution limits over 2012 to 2014, the mobile application can provide a sum of $3,100 and $3,300 considering the user's health insurance plan changes in 2013.

The user made contributions of $3,100 in 2012 and of $3,300 in 2014. For instance, if the user paid a qualifying medical expense of $1,000 in 2012, the user can take a tax-free reimbursement of $1,000. Similarly, if the user paid a qualifying medical expense of $500 in 2014, the user can take a tax-free reimbursement totaling $1,500, a sum of 1,000 and $500 as of 2014, assuming the initial reimbursement of $1,000 was not previously claimed. The mobile application is configured to provide available contribution limit for a given year reflecting the amount of reimbursement made and a reminder of further available limits.

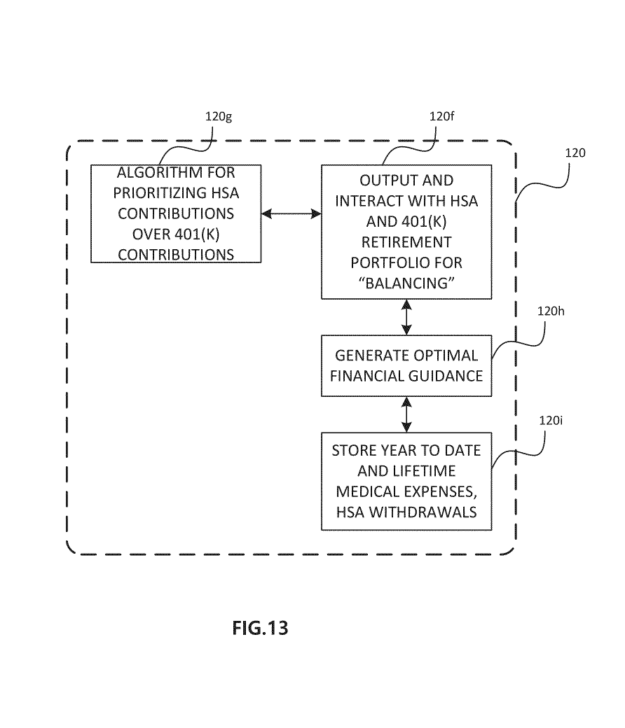

Another embodiment of the present disclosure will be described hereinafter in greater detail referring to FIG. 13. FIG. 13 illustrates a general block diagram of computing unit 120 for managing healthcare transaction data relative to retirement strategy according to another embodiment of the present disclosure.

To build maximum savings and long-term economic value for a user, the mobile application is configured to provide an optimal financial guidance. Compared to Individual Retirement Account (“IRA”), traditional retirement wealth building accounts, HSAs have several benefits. For example, funds in HSAs can be used at any age for qualified medical expenses and is deposited amounts are tax-free when used for this reason. For withdrawals that are not used for qualified medical expenses, a 20% penalty tax applies up to age 65, after which no “early withdrawal” penalty applies and only income tax is due. With an IRA, a 10% penalty tax is applied for early withdrawals before the age of 59½. HSAs have no required minimum distributions while IRAs do. Likewise, HSAs are both similar and distinct from 401(k)'s, employer-sponsored defined contribution retirement plans. For instance, 401(k) and HSAs have different contribution maximum. 401(k)'s have strict withdrawal eligibility whereas funds in HSAs can be withdrawn at any time for qualified medical expenses. Thus, the user needs to study the differences among the available retirement plans and know how to apply the knowledge to a given situation to maximize his or her savings. The mobile application can be configured to provide various algorithms to seek an optimized strategy for the user. For instance, the mobile application can be configured to prioritize HSA contributions over 401(k) contributions in a step 120g. Then, computing unit 120 outputs and interact with HSAs and 401(k) retirement portfolio for balancing and maximizing the sum thereof in a step 120f. When computing unit 120 calculates an optimal distribution between HSA contributions and 401(k) contributions, computing unit 120 generates the optimal financial guidance to the user and displays it in a step 120h. The computing unit 120 stores year to date, lifetime medical expenses, and HSA withdrawals in memory unit 130 in step 120i, and considers such data to provide the user with the optimal financial strategy.

For instance, according to another embodiment of the present disclosure, the user can set a payroll allocation prioritization so that it maxes the user's 401(k) match first, and then decide how much the contribution will be made in HSAs. For instance, if the user's employer provides 401(k) match up to $5,000, the mobile application is configured to calculate a distribution between contributions to a 401(k) and a HSA in consideration of the user's income in a given year and a limit of 401(k) match limits.

According to another embodiment of the present disclosure, the user can set a rule for a ratio between 401(k) and HSAs. For instance, the mobile application can be configured to distribute 5% of the user's annual income to 401(k) and 2.5% to HSAs.

According to another embodiment of the present disclosure, the user can set a maximum amount of an investment either in 401(k) or HSAs and a ratio of investment therebetween. For instance, if a maximum amount of the investment per year set by the user is $7,000, the mobile application can be configured to distribute 70% of $7,000 to 401(k) and 30% of $7,000 to HSAs.

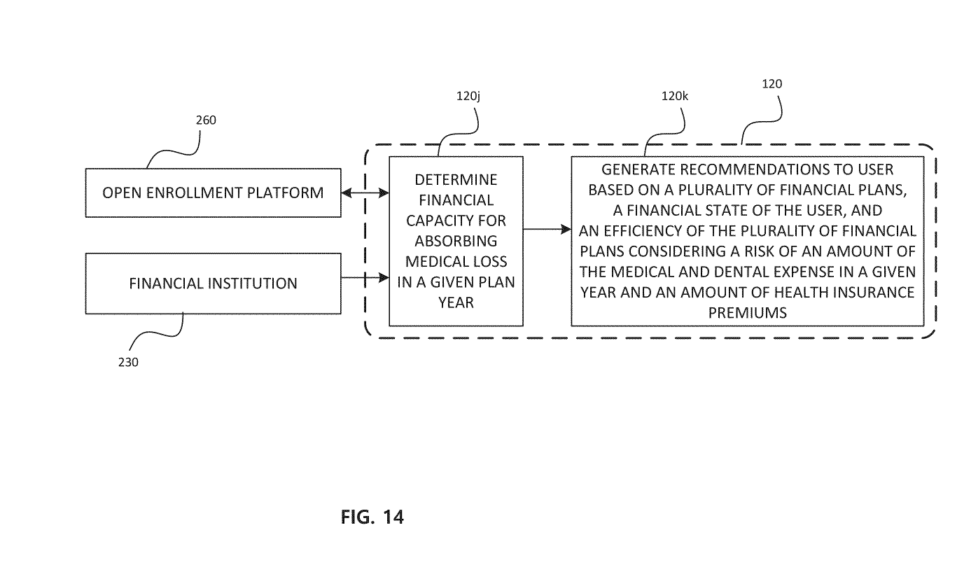

Another embodiment of the present disclosure will be described hereinafter in greater detail referring to FIG. 14. FIG. 14 illustrates a general block diagram of computing unit 120 for managing healthcare transaction data for determining financial capacity according to another embodiment of the present disclosure. Computing unit 120 is configured to communicate with financial institution 230 and an open enrollment platform 260 to determine financial capacity of the user for absorbing medical loss in a given plan year in a step 120j. In a step 120k, computing unit 120 generates recommendations to the user based on at least one of a plurality of financial plans, a financial state of the user, and an efficiency of the plurality of financial plans considering a risk of an amount of the medical and dental expense in a given year and an amount of health insurance premiums.

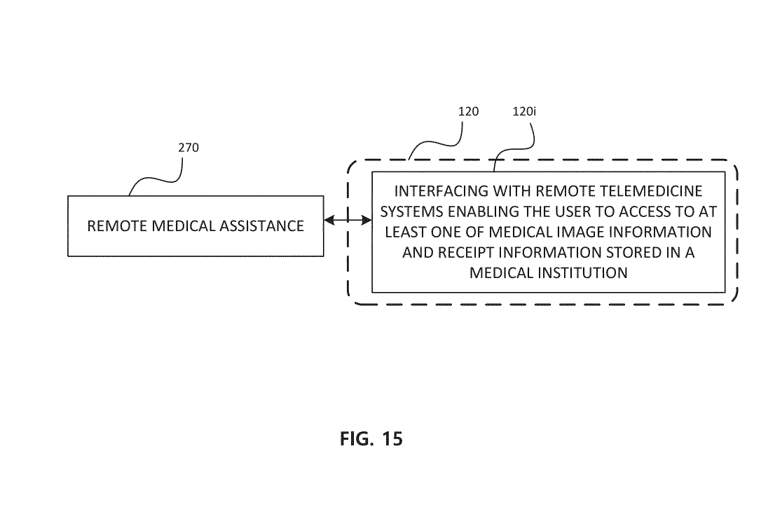

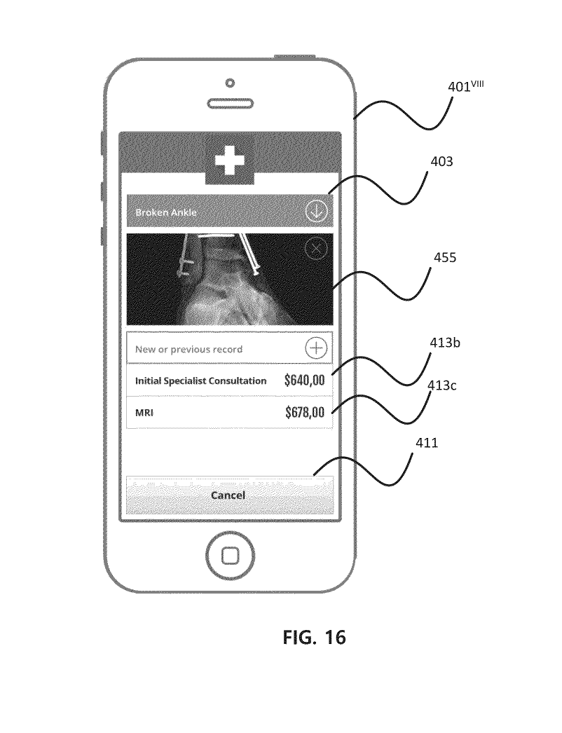

Another embodiment of the present disclosure will be described hereinafter in greater detail referring to FIGS. 15 and 16. FIG. 15 illustrates a general block diagram of computing unit 120 for managing healthcare transaction data relative to remote medical assistance according to another embodiment of the present disclosure. FIG. 16 illustrates another exemplary user interface 401 depicting a screen shot of medical event pictures and associated information. Computing unit 120 is configured to interact with remote medical assistance 270 enabling the user to access to at least one of medical image information and receipt information stored in a medical institution in a step 1201. In addition to the medical expense receipts, as depicted in FIG. 16, the mobile application is configured to store any file (image, text, etc.) including, for instance, the picture of the x-ray in a box 455 on the broken ankle. This may have some utility for the user as people do not keep their medical records as they move from employer to employer and from geography to geography. HSAs have economic value to the user and the user may find a benefit to storing other health related files in the mobile application. Although the user may cease employment with the employer during the period which the mobile application was first downloaded, the user will still have the opportunity to maintain all of the user's IRS mandated receipts and other health related information. In FIG. 16, the information associated with the x ray in box 455 are the fee for a specialist doctor's consultation in box 413b, and the fee for an MRI in box 413c. A button 111 is provided to cancel the operation

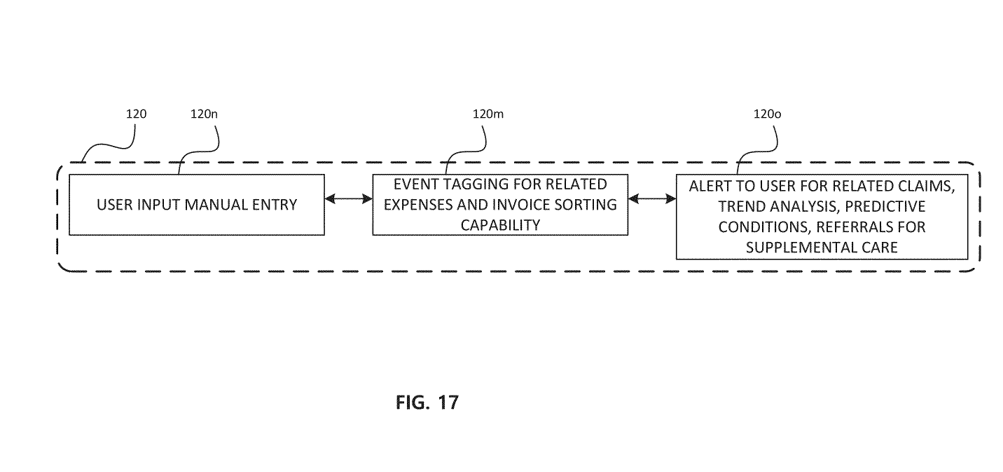

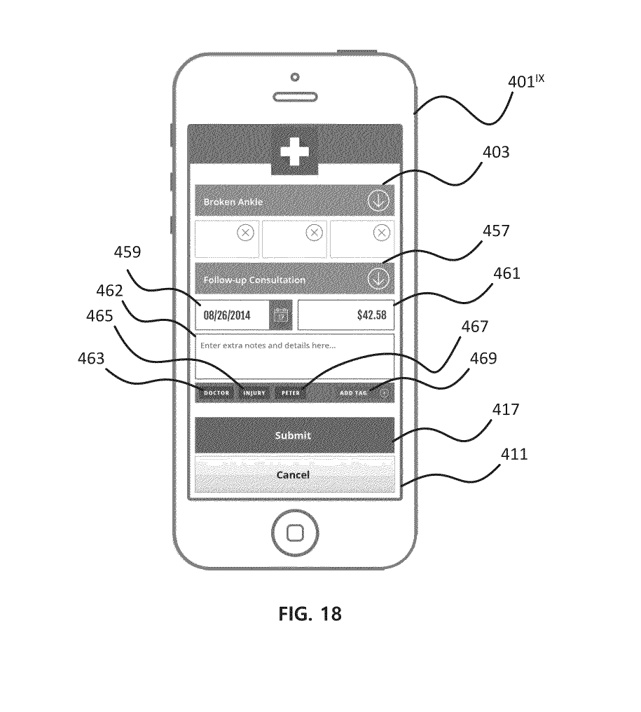

Another embodiment of the present disclosure will be described hereinafter in greater detail referring to FIGS. 17 and 18. FIG. 17 illustrates a general block diagram of computing unit 120 for managing healthcare transaction data with an event tagging.

FIG. 18 illustrates another exemplary user interface 401^{1x} depicting a screen shot of medical event and tagging information. Computing unit 120 is configured to allow the user to manually input a tagging entry to medical event in a step 120n. After a hospital visit, people generally receive multiple bills from an array of service providers. It is difficult for the user to keep up with the volume of expenses and what has been paid, owed and not paid, or what is even obligated. The mobile application is configured to allow the user to keep track in one mobile device 100 all of their expenses and group in multiple arrangements to allow easier tracking of related expenses. For instance, if the user has a broken ankle and three months of follow-up therapy visits. The mobile application provides a convenient digital interface to not only store all health expenses, but determines how much was spent on which medical institution in a given time period, as well as which expenses have already been paid. If the user tags a keyword for events related to the broken ankle, it is convenient for the user to sort out any events related to the broken ankle and to check the status thereof. The event tagging is shown in step 120m and can generate in step 120o as to related claims, trend analysis, predictive conditions and referral for supplemental care.

Referring to FIG. 18, the mobile application displays “Follow-up consultation” button 457 with a date I a box 459 and amount in a box 461. The user can add a tag with “add tag” button 469; e.g., the name of a doctor in a box 463, the type of injury in a box 465, and the name of the patient Peter in a box 467. The user can add or modify the event tagging for related expenses so that the computing unit 120 can enhance invoice sorting capability as performed in step 120m, FIG. 17. The tag information is used to alert the user for related claims, trend analysis, predictive condition, referrals for supplemental care in a box 120o.

Furthermore, message box 462 can be configured to show any detailed information of prescriptions or comments in which phamarcist or doctor provided to the user along with the medical event. Mobile device 100 is configured to communicate with any medical institution or hospital to receive such medical information and display the same in message box 462.

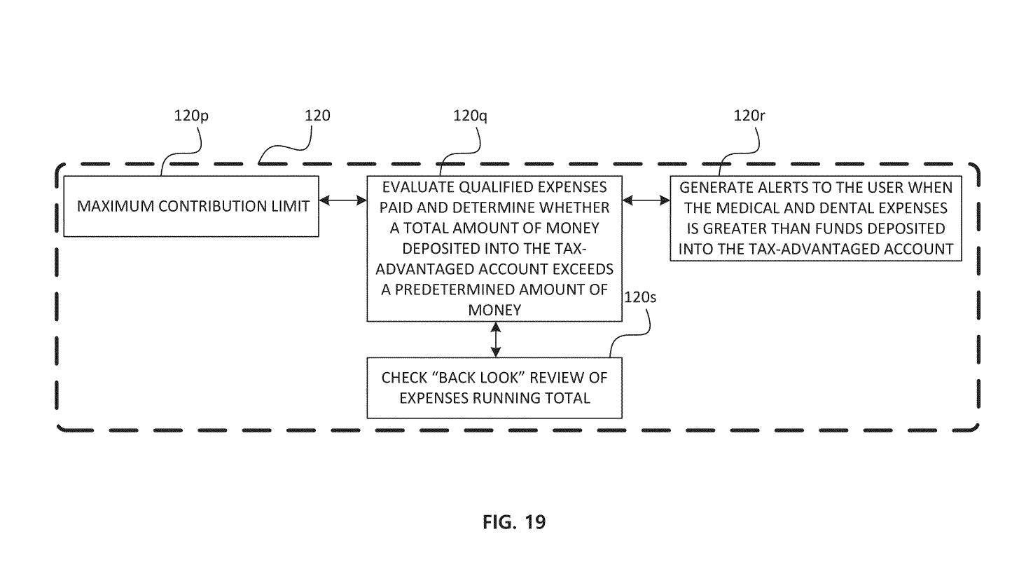

Another embodiment of the present disclosure will be described hereinafter in greater detail referring to FIG. 19. FIG. 19 illustrates a general block diagram of computing unit 120 for managing healthcare transaction data for depositing funds within maximum contribution limits. The user cannot deposit more than a fixed amount in any given year as set by the IRS, and therefore must ensure not to over-contribute to a health savings account, independent of expenses incurred in a given year. As is performed in step 120p, the mobile application helps the user sort expense list for a given plan year and maintain a running total of what expenses have been claimed and what expenses have not been claimed, to ensure the user complies with Federal tax laws.

Computing unit 120 is configured to keep updated for maximum contribution limits in a step 120q. The maximum contribution limits can vary each year. According to IRS regulations, HSAs holders can choose to save up to $3,300 for an individual and $6,550 for a family for 2014. Computing unit 120 is configured to evaluate qualified expenses paid and determine whether a total amount of money deposited into the HSAs exceeds a predetermined amount of money in a step 120p and check “look back” review of expenses running total in a step 120s. The mobile application is configured to generate alerts to the user when the medical and dental expenses are greater than funds deposited into the HSAs in a step 120r.

The mobile application is configured to provide the user with a more data-informed decision process relative to upcoming open enrollment health expenses. The mobile application is a repository of the user's health expenses over time and informs the user of historic expenses incurred. The mobile application actually tracks the user's health transactions over time with details. The mobile application is configured to calculate an efficiency of insurance plan the user has used by calculating whether it is advantageous to trade off higher monthly health insurance premiums in exchange for higher theoretical exposure in a given year or it is advantageous to trade off lower monthly premiums in exchange for higher deductibles. Over time the mobile application is configured to provide more sophisticated health insurance decision support tools taking into account a user's income and personal assets to determine a more precise risk calculation.

The mobile application is configured to contain a planning tool and alerts for upcoming events, such as a child's immunization schedule, multiple doctor visits as part of chronic disease management, etc. As the mobile application enables the user to anticipate and plan for such events the mobile application can provide better guidance associate with these knowable interactions with the health system.

The methods described herein may be implemented in software, hardware, or a combination thereof, in different embodiments. In addition, the order of method may be changed, and various elements may be added, reordered, combined, omitted, modified, etc. Various modifications and changes may be made as would be obvious to a person skilled in the art having the benefit of this disclosure.

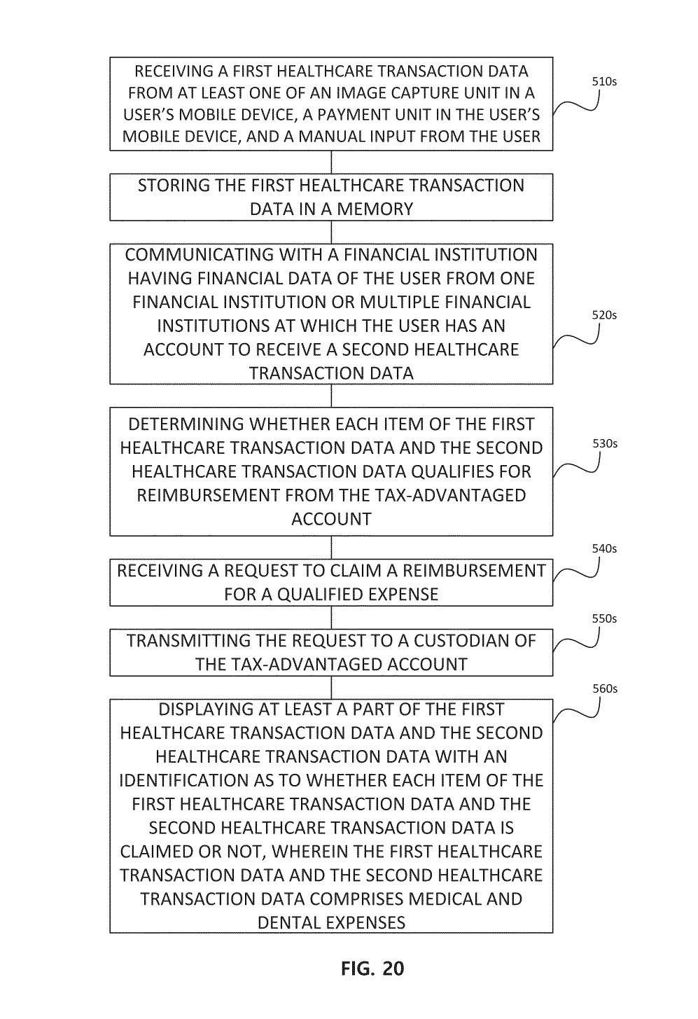

FIG. 20 is a flow chart of a method for managing healthcare transaction data according to another embodiment of the present disclosure. A method for managing healthcare transaction data for tax-advantaged accounts is provided. The method includes receiving a first healthcare transaction data from at least one of an image capture unit in a user's mobile device, a payment unit in the user's mobile device, and a manual input from the user in a step S105, storing the first healthcare transaction data in a memory unit in a step 520S, communicating with a financial institution having financial data of the user from one financial institution or multiple financial institutions at which the user has an account to receive a second healthcare transaction data in a step 530S, determining whether each item of the first healthcare transaction data and the second healthcare transaction data qualifies for reimbursement from the tax-advantaged account in a step 540S, receiving a request to claim a reimbursement for a qualified expense in a step 550S, transmitting the request to a custodian of the tax-advantaged account in a step 560S, and displaying at least a part of the first healthcare transaction data and the second healthcare transaction data with an identification as to whether each item of the first healthcare transaction data and the second healthcare transaction data is claimed or not, wherein the first healthcare transaction data and the second healthcare transaction data comprises medical and dental expenses in a step 570S.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments herein is intended to be illustrative, but not limiting, of the scope of the invention, which is set forth in the following claims.

What is claimed is:

1. A mobile device for managing healthcare transaction data, the device comprising:
an I/O interface unit configured to receive an input from a user;
an image capture unit configured to capture an image and coupled to the I/O interface unit;
a computing unit coupled to the I/O interface unit and configured to receive at least one of:
a first healthcare transaction data from at least one of the image capture unit in the mobile device, a payment unit in the mobile device, and the input from the user, and
a second healthcare transaction data from a financial institution having financial data of the user at which the user has an account,
wherein the computing unit is configured to determine whether the first healthcare transaction data and the second healthcare transaction data include a qualifying expense for reimbursement in accordance with a predetermined set of rules;
a network unit coupled to the I/O interface unit and configured to communicate with the financial institution and to transmit a claim request documentation for the qualifying expense to at least one of a health savings account custodian and a health insurance provider;
a memory unit coupled to the I/O interface unit and configured to store the first healthcare transaction data and the second healthcare transaction data;
a display unit coupled to the I/O interface unit and comprising a display panel configured to display a claim identifier for each item of the first healthcare transaction data and the second healthcare transaction data.

2. The mobile device of claim 1, wherein the payment unit is coupled to the I/O interface unit and further comprises a near field communications (NFC) unit, and wherein the NFC unit is configured to make mobile payments with a NFC reader device.

3. The mobile device of claim 1, wherein the computing unit comprises an optical character recognition (OCR) software and is configured to convert the image into a machine-encoded text.

4. A computer program product being executable by a mobile device to perform a method for managing healthcare transaction data, wherein the mobile device has an I/O interface unit, an image capture unit, a payment unit, a network unit, a computing unit, a display unit, and a memory unit processor, the method comprising:
receiving a healthcare transaction data from at least one of the image capture unit, the payment unit, an input from the user from the I/O interface unit, and a financial institution at which a user has an account;
determining, in the computing unit, whether the healthcare transaction data include a qualifying expense for reimbursement in accordance with a predetermined set of rules;
transmitting, via the network unit, a claim request documentation for the qualifying expense to at least one of a health savings account custodian and a health insurance provider;
displaying, on the display unit, a claim identifier for each item of the healthcare transaction data; and,
generating, in the computing unit, a predetermined form in an electronic format based on the healthcare transaction data.

5. The computer program product of claim 4, wherein the method further comprises tagging at least one item of the healthcare transaction data with an event name.

6. The computer program product of claim 5, wherein the method further comprises sorting the tagged item in accordance with the event name.

7. The computer program product of claim 6, wherein the sorting further comprises displaying a status of the tagged item of the healthcare transaction data as to whether the tagged item was paid or not and as to how much was spent and on whom during a given time period.

8. The computer program product of claim 4, wherein the method further comprises: determining financial capacity of the user for absorbing medical loss in a given plan year based on a predetermined condition, and
generating recommendations to the user based on at least one of
a plurality of financial plans,
a financial state of the user, and
an efficiency of the plurality of financial plans considering a risk of an amount of the medical and dental expense in a given year and an amount of health insurance premiums.

9. The computer program product of claim 4, wherein the method further comprises generating alerts if the claim request documentation is processed in a different manner from a predetermined rule.

10. The computer program product of claim 4, wherein the method further comprises interfacing with remote telemedicine systems enabling the user to access to at least one of medical image data and receipt data stored in a medical institution.

11. The computer program product of claim 4, wherein the method further comprises planning a medical schedule on a calendar software application installed in the user's mobile device.

12. The computer program product of claim 4, wherein the step of receiving the healthcare transaction data from the image capture unit in the user's mobile further comprises extracting financial data from an image obtained by the image capture unit.

13. The computer program product of claim 4, wherein the method further comprises:
determining whether a total amount of money deposited into the tax-advantaged account exceeds a predetermined amount of money, and
displaying the total amount of money deposited into the tax-advantaged account in a given year.

14. The computer program product of claim 13, wherein the method further comprises:
generating alerts to the user when the medical and dental expenses is greater than funds deposited into the tax-advantaged account, and
displaying the qualifying expense for reimbursement from the tax-advantaged account so that the user submits the claim request documentation for the reimbursement.

15. The computer program product of claim 4, wherein the communicating comprises extracting medical data from the healthcare transaction data according to a predetermined standard.

16. The computer program product of claim 4, wherein the payment unit is located at the user's mobile device and is configured to make mobile payments with a near field communications (NFC) reader device.

17. A healthcare transaction data management system comprising:
receiving a first healthcare transaction data from at least one of an image capture unit in a user's mobile device, a payment unit in the user's mobile device, and a manual input from the user;
communicating with a financial institution having financial data of the user from one financial institution or multiple financial institutions at which the user has an account to receive a second healthcare transaction data;
determining whether the first healthcare transaction data and the second healthcare transaction data include a qualifying expense for reimbursement;
transmitting a claim request documentation for the qualifying expense to at least one of a health savings account custodian and a health insurance provider;
displaying a claim identifier for the first healthcare transaction data and the second healthcare transaction data on a display panel;
tagging at least one item of the first and second healthcare transaction data with an event name;
sorting the tagged item in accordance with the event name; and
displaying a status of the tagged item of the first and second healthcare transaction data as to whether the tagged item was paid or not and as to how much was spent on which institution in a given time period,
wherein the first healthcare transaction data and the second healthcare transaction data comprise expenses.

18. The system of claim 17, wherein the method further comprises:
generating alerts if the claim request documentation is not properly processed,
generating a form based on the first healthcare transaction data and the second healthcare transaction data,
determining financial capacity of the user for absorbing medical loss in a given plan year, and
generating recommendations to the user based on at least one of
a plurality of financial plans,
a financial state of the user, and
an efficiency of the plurality of financial plans considering a risk of an amount of the medical and dental expense in a given year and an amount of health insurance premiums.

19. The system of claim 17, wherein the method further comprises:
capturing financial data from an image obtained by the image capture unit,
extracting medical data from the first healthcare transaction data using Optical character recognition (OCR) software and the second healthcare transaction data according to a predetermined standard;
interfacing with remote telemedicine systems enabling the user to access to at least one of medical image data and receipt data stored in a medical institution,
planning a medical schedule on a calendar software application installed in the user's mobile device;
determining whether a total amount of money deposited into the tax-advantaged account exceeds a predetermined amount of money; and
displaying the total amount of money deposited into the tax-advantaged account in a given year;
generating alerts to the user when the medical and dental expenses is greater than funds deposited into the tax-advantaged account; and
displaying the qualifying expense for reimbursement from the tax-advantaged account so that the user submits the claim request documentation for the reimbursement.

20. The system of claim 17, further comprising:
providing available contribution limit reflecting an enrollment of the user and the amount of reimbursement that is made over a requested period of time; and
providing a reminder of the available contribution limits.
